(19) United States
(12) Patent Application Publication
(10) Pub. No.: US 2005/0257017 A1
(43) Pub. Date: Nov. 17, 2005

(54) Method and apparatus to erase hidden memory in a memory card

(76) Inventor: Hideki Yagi, Bellevue, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/846,757

(22) Filed: May 14, 2004

(51) Int. Cl. G06F 12/14

(52) U.S. Cl. 711/163; 711/103; 711/154

(57) ABSTRACT

Methods, apparatus, software and systems for securely erasing data from a memory card. A number of hidden spare blocks of memory in an inaccessible region of each memory bank is determined. A block of memory is repeatedly overwritten with a data pattern in each memory bank up to the number of hidden spare blocks in one embodiment. A block of memory is repeatedly erased in each memory bank up to the number of hidden spare blocks in another embodiment. The blocks of memory in the accessible region of each memory bank are erased or overwritten with the data pattern.

### FIELD

Embodiments of the invention generally relate to erasing non-volatile memory cards and more particularly to erasing memory in an SD memory card that is ordinarily hidden from a host system.

### GENERAL BACKGROUND

Memory cards have come into broad use by consumers as the markets for products such as digital still cameras continues to expand. There are various types of memory cards available such as PC Card™, CompactFlash™, SmartMedia™, MultiMediaCard (MMC), Memory Stick, Memory Stick Pro, Secure Digital (SD) Memory Card, and xD-Picture Card™.

When a memory card is disposed of or transferred to another party, how data therein is erased may become an important issue with respect to data security. That is, data erased from a memory card by ordinary means may still exist in the internal memory.

When data recorded on a memory card is no longer needed, a typical “erase” operation is usually performed that appears to delete the data from the card. In reality, however, erasure merely makes the data inaccessible by normal means, such as from a host operating system. The data itself may still exist in the internal memory of the memory card. It is therefore possible for unscrupulous users to read sensitive data left on a memory card, and to use it in unforeseen ways.

Moreover, the data within the card may be licensed such as a licensed program that has transfer restrictions. Transferring a storage device to another user without erasing the licensed program (e.g. operating system software, application software, etc.) stored therein, may violate the software licensing provisions.

Thus, it is desirable to more securely erase data within a memory card.

### BRIEF DESCRIPTION OF THE DRAWINGS

Features and advantages of embodiments of the invention will become apparent from the following detailed description in which:

FIG. 1 is an exemplary block diagram of a system to securely erase data from a memory card.

FIG. 2 is a more detailed block diagram of a memory card.

FIG. 3 is an exemplary block diagram illustrating the memory hierarchy of a flash memory core.

FIGS. 4A-4D illustrate an exemplary operation of writing a new page of data into a block of pages.

FIG. 5 is an exemplary diagram of a flash memory core and a level of its hierarchy to illustrate the logical difference between a user accessible block and a hidden spare block of memory in a bank of memory.

FIGS. 6A-6C are exemplary diagrams of a 64 megabyte flash memory core and a level of its hierarchy to illustrate the calculations made to determine how to erase or overwrite the hidden spare blocks of memory in each bank.

FIG. 7 is a first flowchart of a first exemplary portion of the software routine to securely erase a memory card.

FIG. 8 is a second flowchart of a second exemplary portion of the software routine to securely erase a memory card.

FIG. 9 is a third flowchart of a third exemplary portion of the software routine to securely overwrite the hidden spare blocks of memory in each bank of a memory card using multiple write operations.

FIG. 10 is an alternative flowchart of the third exemplary portion of the software routine to securely erase the hidden spare blocks of memory in each bank of a memory card using multiple erase operations.

### DETAILED DESCRIPTION

Embodiments of the invention set forth in the following detailed description generally relate to methods, apparatus, software and systems for securely erasing data from a memory card. According to one embodiment of the invention, a method is provided for securely erasing a memory card. The method determines a size of a hidden memory region within a storage medium of the memory card; issues a first command to erase a block of data stored in the hidden memory region; and then repeatedly issues the first command to erase another block of data in response to the size of the hidden memory region.

In another embodiment of the invention, a processor readable storage medium is provided with program code recorded therein to determine a number of spare blocks within a hidden memory region of each memory bank within the memory card. The program code is created to generate (i) a first command to erase blocks of data stored in the spare blocks of the hidden memory region of each memory bank in response to the number of spare blocks within the hidden memory region of each memory bank, and
(ii) a second command to erase blocks of data within accessible memory regions of each memory bank.

In yet another embodiment of the invention, a system of elements is provided including a flash memory card and a memory coupled to a host bus that stores a program having instructions that the system executes to securely erase the flash memory of the flash memory card, including spare blocks within a hidden memory area of the flash memory.

In still another embodiment of the invention, another method for securely erasing a memory card is provided. This method includes determining a number of memory banks in the memory card, determining a size of a block of memory in each memory bank, determining a number of hidden spare blocks of memory in an inaccessible region of each memory bank, and repeatedly erasing a block of memory in each memory bank up to the number of hidden spare blocks of memory in the inaccessible region of each memory bank.

In still another embodiment of the invention, yet another method for securely erasing a memory card is provided, including determining a number of memory banks in the memory card; determining a size of a block of memory in each memory bank; determining a number of hidden spare blocks of memory in an inaccessible region of each memory bank; and repeatedly overwriting a block of memory with a data pattern in each memory bank up to the number of hidden spare blocks of memory in the inaccessible region of each memory bank. Each method may further include erasing blocks of memory in the accessible region of each memory bank.

In still another embodiment, an apparatus is provided that includes a determination means, a first command generating means, and a second command generating means. The determination means is for determining a number of spare blocks of a hidden memory region within each bank of a storage medium of the memory card. The first command generating means is for generating a first command to erase all blocks of data stored in an accessible memory region of each bank. The second command generating means is for generating a second command to erase a block of data stored in a spare block of the hidden memory region in each bank wherein the second command generating means repeatedly generate the second command in response to the number of spare blocks in each bank.

For security reasons it is useful to completely erase all data that stored within a flash memory card. This is particularly so when disposing or transferring a flash memory card to another person. However, typical erasing methods used by a host system are unable to erase hidden memory areas within a flash memory card. The Flash memory card usually includes hidden memory area for several purposes. A host cannot read, write, or erase this hidden memory area by any direct means because it is hidden from the outside. Therefore, even if a host system erases all the memory area within a memory card that it can access, data still remains in the memory card within the hidden memory area.

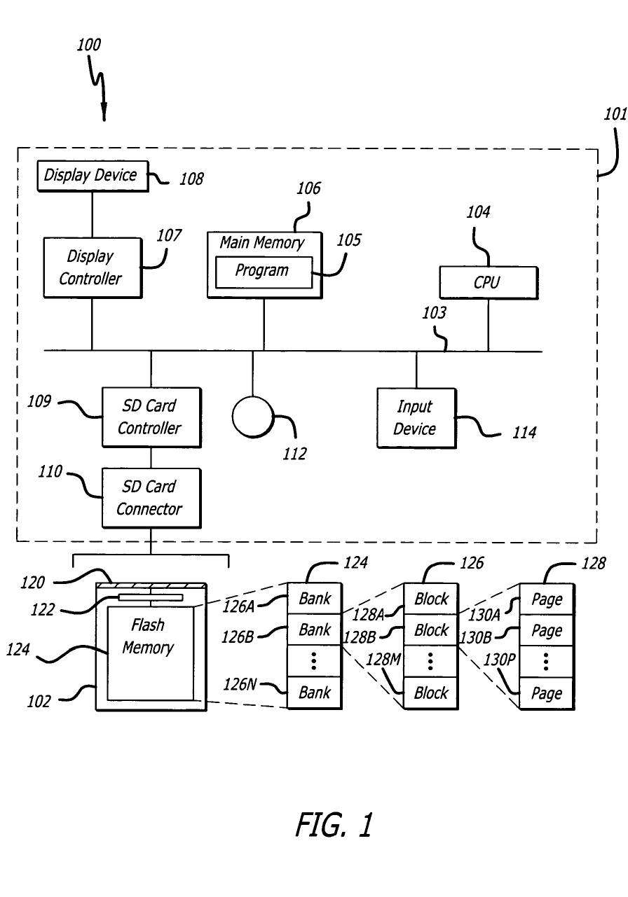

Referring to FIG. 1, a block diagram of a system 100 for securely erasing a memory card is illustrated. The system 100 includes a host computer 101 and a memory card 102 as is illustrated. With the memory card 102 inserted into the host system 101, the system may erase the accessible memory blocks within the flash memory of the memory card 102 as well as the inaccessible or hidden memory blocks. The term flash memory used herein refers to electrically erasable programmable read only memory (EEPROM). While EEPROM memory is a preferred embodiment of the storage medium for the memory core of the memory card, the embodiments of the invention may also be applicable to other types of memory.

The host computer system 101 includes a microprocessor 104, a main memory 106, a display controller 107, a display device 108, a memory card controller 109, a memory card connector 110, a disk drive storage unit 112, and an input device 114 coupled together as shown and illustrated in FIG. 1. These elements of the host computer system 101 may communicate with one another over one or more busses 103.

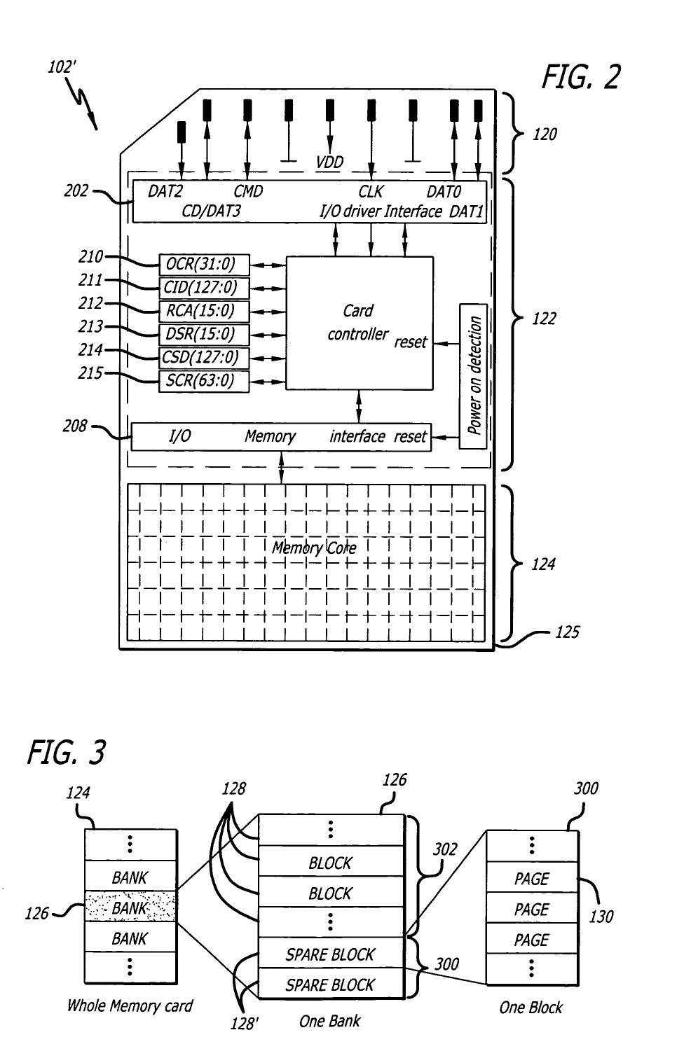

The memory card 102 includes a memory card connection 120, a controller 122, and a flash memory 124 coupled together as shown and illustrated in FIG. 1. Other elements that may be included as part of the memory card 102 are described below with reference to FIG. 2.

With the memory card 102 coupled to the host system 101, the flash memory 124 can typically be viewed by the host system 101 as having one or more banks of memory 126A-126N. Each bank 126 may have one or more blocks of memory 128A-128M. Each block may have one or more pages 130A-130P of memory. However within each bank, there may be other blocks of memory that are hidden from normal access by the host that are used for varied purposes by the memory card 102.

A program 105 may be read from the disk drive unit 112 or other fixed storage and temporarily stored into the main memory 106 of the host computer system 101. The program 105 represents one embodiment of the invention that is performed by the host computer system to securely erase data from the memory card 102. The program 105 may stand alone or be part of a software driver for memory cards in an operating system for a computer, such as Microsoft's Windows operating system, Apple's Macintosh operating system, or Linux operating system, or alternatively, the program 105 may be part of a software application. Alternatively, the operations of the program 105 may be embodied in hardware or software of the memory card controller 109 or the controller 122 of the memory card 102 itself. In which case, a special command may be given to execute the operations of the program 105 to securely erase the flash memory in these embodiments of the invention.

Referring now to FIG. 2, a detailed block diagram of an exemplary flash memory card 102′ is illustrated. The flash memory card 102′ includes a memory card connection 120, a controller 122, and a flash memory core 124 housed within a housing 125. The flash memory core 124 may be one or more EEPROM integrated circuits or other type of memory integrated circuits. The memory card connections 120 maybe formed by pads of an edge connector of a printed circuit board. That is, the memory card connection 120, the controller 122, and the flash memory core 124 may be mounted together to a printed circuit board and enclosed in the housing 125 for protection.

The controller 122 may also be formed of one or more integrated circuits. The controller 122 includes an I/O driver interface 202, a card controller 204, a power on detector 206, an I/O memory interface 208, and a plurality of registers 210-215 coupled together as shown and illustrated in FIG. 2.

Registers 210-215 are utilized to meet certain specification of the standards for a memory card. In one embodiment of the invention, the memory card 102′ is a secure digital (SD) memory card. In accordance with the SD memory card specifications, register 210 is an operations condition register (OCR). Register 211 is a card identification number register (CID). Register 212 is a relative card address register (RCA). Register 213 is a drive stage register (DSR). Register 214 is a card specific data register (CSD). Register 215 is a secure digital configuration register (SCR).

The relative card address register provides a local system address for the card which is dynamically suggested by the memory card and approved by a host during initialization. The card identification number (CID) register provides a relative unique number for individual identification of the memory card. The driver stage register maybe utilized to configure the cards output drives. The card specific data register contains information about the card operations or conditions. Thus the configuration register may contain information about the SD memory cards special features and capabilities.

The I/O memory interface 208 of the controller 122 interfaces to the one or more integrated circuits that form the flash memory core 124. The I/O driver interface 202 of the controller 122 provides an interface to the host computer system via the pads of the electrical connection 120.

Referring now to FIG. 3, a block diagram of the flash memory core 124 and its structure is used to illustrate hidden or spare memory blocks 128′ of an internal hidden memory area 300 in each bank of memory. The flash memory in the memory card is formed into one or more banks 126 of memory. Each bank 126 of memory is formed by a plurality of blocks 128,128′ of memory. The size of a block may be fixed, designating a number of bytes per block for example.

Within each bank 126 of memory is the hidden memory area 300 and a normal or accessible memory area 302. The normal or accessible memory area 302 is accessible to a user through a host system. The normal or accessible memory area 302 includes memory that is user read/writable and may further include memory with data that is secured from being copied by a user. Normal or accessible memory area 302 includes both the “normal area” and the “secured data area”, which are user accessible. The normal or accessible memory area 302 can be readily erased or overwritten by a host system. The hidden memory area or region 300 includes memory that is used for the memory card system (e.g., passwords, system settings, etc.) and spare memory that is used for writing data to the memory card, both of which are not accessible to a user. The hidden memory area or region 302 includes both the “system area” and the “hidden area”.

Each block 128,128′ of memory has a plurality of pages 130 of memory. A page 130 of memory is the minimum unit of memory to which normal read and write operations are performed. A page 130 of memory may typically address 1024 words or bytes of data. A byte typically is 8 bits of data but may be other bit widths as well.

In the embodiments of the invention, a block of memory is the accessing unit of memory that is used to perform one erase/overwrite operation to securely erase the flash memory, including the hidden memory area 300. While a block of memory is the unit size of memory illustrated and described in the embodiments of the invention disclosed herein, embodiments of the invention may be readily extended to other unit sizes of memory.

One or more blocks of memory, such as spare blocks 128′, are used as an internal hidden memory area 300 within a bank. The other blocks 128 of memory provide an accessible or visible memory area 302. The internal hidden memory area is hidden from the host system and is not directly user accessible. That is, the host computer system 101 cannot directly access the spare blocks 128′. Note that the term “spare block” 128′ may also be referred to herein as a “hidden block” 128′.

The memory blocks that are selected to be hidden or spare blocks 128′ are not fixed at a specific physical address space. That is, the hidden or spare blocks 128′ move from one physical block to another within the physical address space by a write or an erase operation. To understand why this is so, there are limits to the number of erase and write cycles that can be made to EEPROM memory. The controller 122 may utilize the hidden or spare blocks 128′ to spread out the number of erase and write cycles over the entire memory core, so as to prolong the life of the memory capacity in the memory card.

Because the spare blocks 128′ are hidden from the host computer system, it cannot directly delete or erase the data therein. While the host computer can directly delete or erase all data in the blocks 128 of the accessible area 302, the data stored in the spare blocks 128′ of the internal hidden memory area or inaccessible area 300 still exists. In order to truly provide a secure erase of data in a memory card, the data in the internal hidden memory area or inaccessible area 300 are also deleted or erased by the embodiments of the invention.

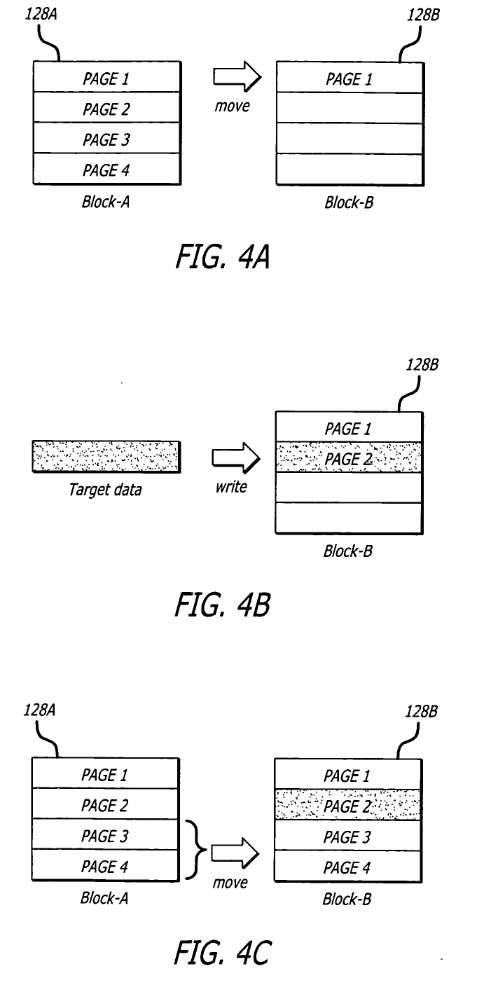

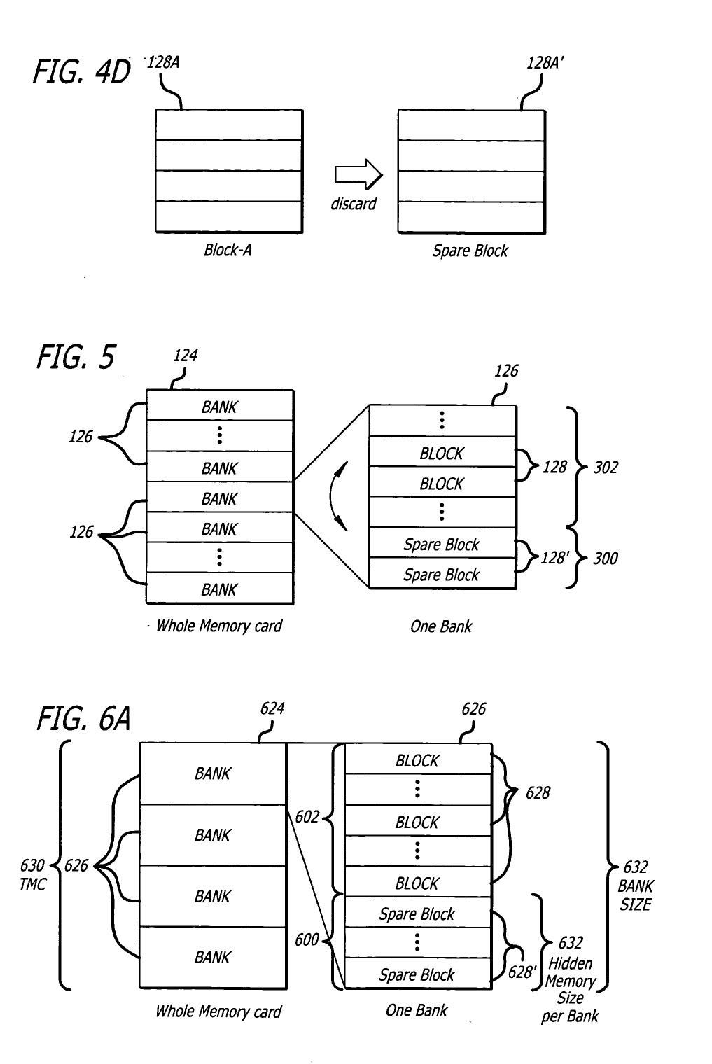

The embodiments of the invention are based on the way in which a page of data is written into a block of memory in the memory card and how much memory is erased all at once in flash memory. Flash memory does not allow a page of data to be directly written into a block. The controller first erases a block of memory including the specified area prior to writing data therein. The minimum amount of memory that is erased at once in a flash memory is a block of memory and not a page of memory. For example, assume there are four pages in each block of memory as is illustrated by blocks 128A-128B of FIGS. 4A-4E.

Referring now to FIG. 4A, assume that data is to be overwritten to page 2 of memory Block-A 128A. The flash memory card internally performs the following operations:

(1) New Block Allocation

The memory card allocates a new block, Block-B 128B, one of the unused hidden blocks 128′ which are hidden from the host in the internal hidden memory area 300 of a given bank.

(2) Pre-Moving

For pages that are not being modified and located above the page being modified, copy the original pages from Block-A 128A to the same page locations in Block-B 128B. In this example, page 2 is the page that is being modified with target data from that stored in block 128A. Thus, page 1 data of Block-A 128A is copied and moved/written into page 1 of Block-B 128B as is illustrated by FIG. 4A.

(3) Writing Target Data

As page 2 is the page being modified by the target data, the target data is written into page 2 of Block-B 128B as is illustrated by FIG. 4B.

(4) Post-Moving

For pages that are not being modified and are located below the page being modified, copy the original pages from Block-A 128A to the same page locations in Block-B 128B. As discussed previously, page 2 is the page that is being modified with target data in this example.

Therefore in this example, the data of page 3 and page 4 of Block-A 128A is copied and moved/written into page 3 and page 4 respectively of Block-B 128B as is illustrated by FIG. 4C.

(5) Release Old Block

Block-A 128A initially has a logical address X associated with it while it stores data and is part of the accessible memory area 302. However with Block-B 128B now holding the original data of Block-A but for page 2, the connection between Block-A 128A and the logical address X can be broken. A new connection is then made by and between Block-B 128B and the logical address X. Block-A 128A is free from logical address association and can be discarded to become a hidden or spare block 128A′ of the hidden or spare blocks 128′ within the internal hidden area 300, retaining the existing data.

Referring now to FIG. 5, the physical structure of the flash memory 124 is in part based on the physical structure of one or more EEPROM memory cells. In the design of the flash memory 124, the EEPROM memory cell is arrayed out with a physical addressing structure so that banks 126 of memory are formed out of blocks 128,128′ of memory and the blocks are formed out of pages of memory. To provide the hidden or spare blocks 128′ of memory in the hidden memory area 300, there is not a one to one correspondence between the logical address space and the physical address space of the flash memory in the memory card. Each bank 126 of memory has one or more spare blocks 128′. Note that the term “spare block” 128′ may also be referred to herein as a “hidden block” 128′. The internal hidden area 300 is one or more spare blocks 128′ of each memory bank 126. The spare blocks 128′ in the hidden area 300 may not be consecutive physical blocks of memory but spread out over the physical address space. As illustrated by the double ended arrow in FIG. 5, a currently usable accessible block 128 may be designated as a spare block 128′ at another point in time. Similarly, a current spare block 128′ may be designated as a usable accessible block 128 at another point in time. That is, memory blocks may swap back and forth from being within the internal hidden area 300 and the accessible memory area 302.

For example, based on current semiconductor technology, the minimum size of each one bank is 16 megabytes (MB). For example, if the total capacity of the memory card is to be 64 MB, the flash memory in the card would be constructed of four banks of 16 MB each. As technology improves in the manufacturing processing and design of the memory cell, the size of one bank may increase to 32 MB, 64 MB, and more so that the total capacity of the memory card increases.

As described previously, the Spare Blocks 128′ are used for every write/erase operation in the flash memory. When a block of memory is returned to become the internal hidden memory area, the data stored in the block is retained. To erase the data in the spare blocks, one may first erase all of the accessible memory blocks in each bank and then write invalid data into each bank that is stored in the spare blocks of the hidden memory.

In the embodiments of the invention, the following basic steps may be followed to accomplish this:
(0) Delete, Erase, or Initialize all the accessible memory area which is accessible by a host.
(1) Determine or assuming the total number of banks based on the total memory capacity of the card.
(2) Calculate the total size of a spare block for each bank.
(3) Calculate the size of one block.
(4) For each bank, erase or write invalid data to the same logical address. The size of the write operation is the same as the block size calculated in step 3.
(5) Repeat step 4 until the total amount of data written is equal to the total spare block size in each bank.
(6) Repeat steps 4 and 5 for every bank in the memory card.

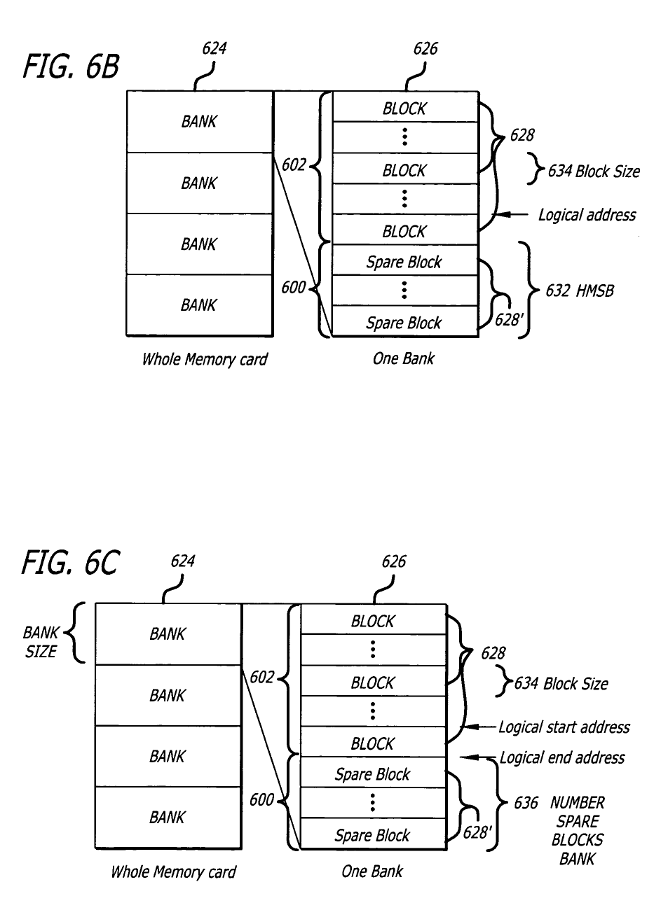

Consider for example a 64 MB SD memory card having a memory 624 with four 16 MB banks 626 as illustrated in FIG. 6A. Each bank 626 includes a plurality of blocks 628 and one or more spare blocks 628′ of memory. The one or more blocks 128′ form the internal hidden area 600 of each memory bank 626. The plurality of blocks 628 form the accessible memory area 602. Spare blocks 628′ swap with other blocks 628 between being in the internal hidden area 600 and the accessible memory area 602. That is the blocks 628′ in the hidden area 600 may not be consecutive blocks but spread out over the physical address space.

With reference to FIGS. 6A-6C and FIGS. 7-10, the following detailed steps may be performed (not all in order) to delete or erase data from the spare blocks 628′ of the internal hidden or inaccessible memory area 600:

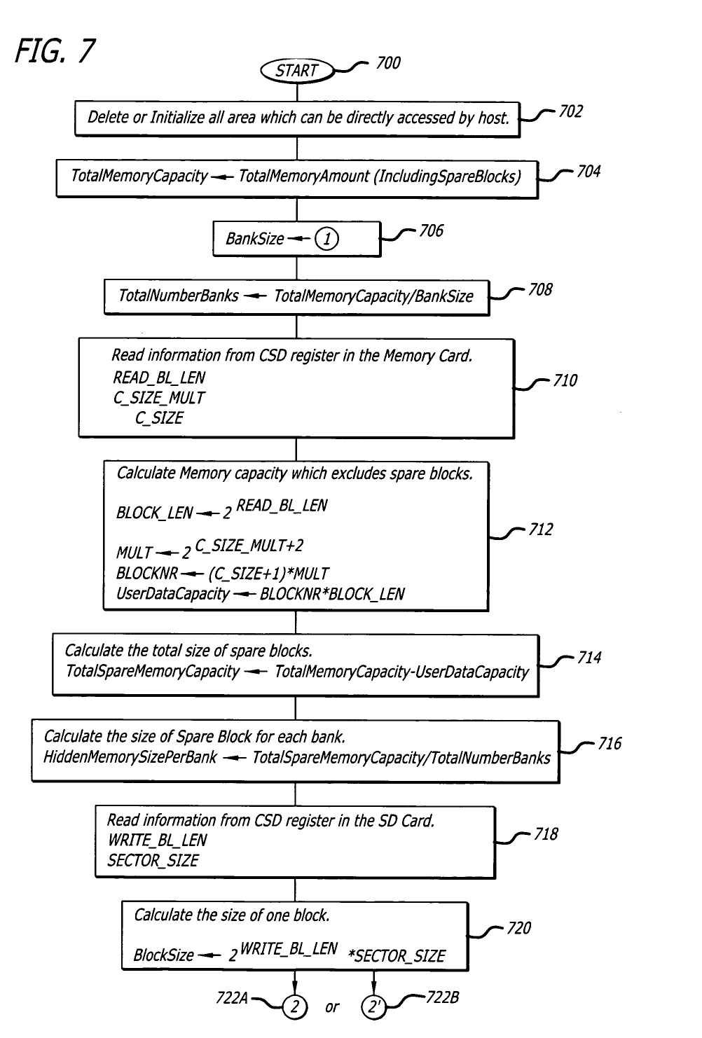

FIGS. 7-10 illustrate flowcharts corresponding to the memory block diagrams of the example of FIGS. 6A-6C. The software flow chart begins at the start box 700.

At block 702, step 0 is performed where all the accessible memory area 602 which is directly accessible to the host is erased, Deleted, or Reformatted/Initialized. This step, step (0), may be performed at the beginning as shown or alternatively, after step (8) just prior to the end at block 924.

The accessible memory area 602 may be erased all at once by a command that physically erases the accessible memory locations or invalid data may be written into the accessible memory locations by executing a sequence of write commands. The invalid data may be all ones such as “0xFF” (FF hexadecimal=11111111), all zeroes 0x00(00 hexadecimal=00000000), alternating ones and zeroes (01010101 or 10101010) or a random pattern of ones and zeroes. In any case, the data is meaningless that is to be written into the memory card to overwrite the memory locations.

At blocks 704 and 706, step 1 is performed.

At block 704, the amount of total memory available including the spare blocks of hidden memory is written into the variable TotalMemoryCapacity (TMC) 630 as indicated by Equation 1A below. The total memory amount including the spare blocks is usually the specified size of the memory card provided by its manufacturer and listed on a surface of the housing 125 of the memory card.
TotalMemoryCapacity←Total Memory Amount including spare blocks Equation 1A:

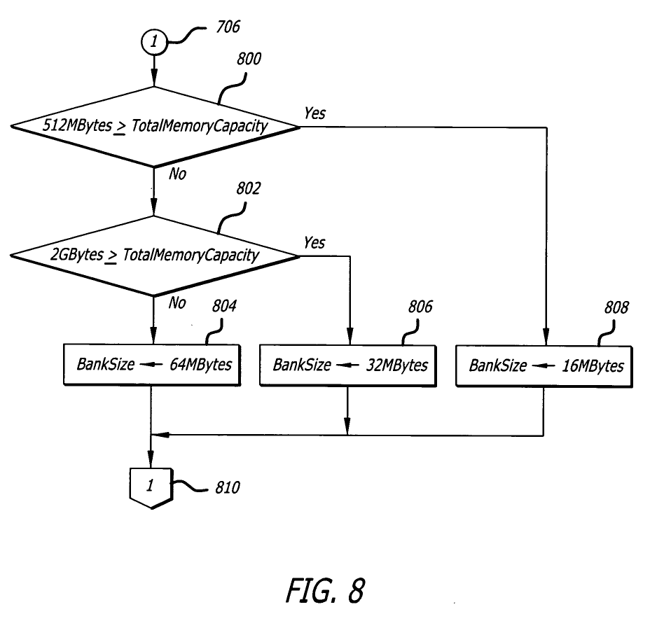

At block 706, the size of memory (BankSize 632) in one bank of memory is determined or assumed. The flow chart of FIG. 8 illustrates how the BankSize is determined.

Referring now to FIG. 8, at block 800 a determination is made as to whether the TotalMemoryCapacity is less than or equal to 512 MB. If the answer is yes, then a jump to block 808 is made. If the answer at block 800 is no, then the software goes to block 802.

At block 808, the BankSize is set to 16 MB as this is typically the flash memory configuration used to form memory cards with 512 MB or less of memory capacity.

At block 802, a determination is made as to whether the TotalMemoryCapacity is less than or equal to 2 gigabytes (GB), the equivalent of 2048 MB. If the answer is yes, then a jump to block 806 is made. If the answer at block 800 is no, then the software goes to block 804.

At block 804, the BankSize is set to 64 MB as this is typically the flash memory configuration used to form memory cards with greater than 2 GB of memory capacity.

At block 806, the BankSize is set to 32 MB as this is typically the flash memory configuration used to form memory cards with 2 GB or less of memory capacity and more than 512 MB of memory capacity.

At block 810, the BankSize has been determined and the software returns to block 706 and then goes to block 708 illustrated in FIG. 7.

Referring now back to FIG. 7, at block 708, the total number of banks (TotalNumberBanks or TNB) in the memory card is determined by dividing the TotalMemoryCapacity by the BankSize as is indicated by Equation 1B below.

TotalNumberBanks=TotalMemoryCapacity/BankSize Equation 1B:

For example, assume the size of each bank is 16 MB in the four memory banks 626 illustrated in FIG. 6A. That is, the BankSize is 16 MB as is illustrated in Equation 1C below.
BankSize=16 MB Equation 1C:

Therefore, the total number of banks may calculated as follows in Equation 1D.

TotalNumberBanks=64 MB/16 MB=4 Equation 1D:

At blocks 710, 712, and 714, step 2 is performed where the total amount of the internal hidden memory area (i.e., the total spare memory capacity) in the flash memory core is calculated.

In order to determine the total amount of the internal hidden memory area in the flash memory core, the amount of accessible memory in the memory card (i.e., UserDataCapacity that does not include the hidden memory) can be subtracted from the total memory capacity of the memory card (i.e., TotalMemoryCapacity that includes the amount of hidden memory). UserDataCapacity may be determined from register settings in the memory card. For an SD memory card, the UserDataCapacity may be calculated from register information stored in the CSD register 214 of an SD memory card.

At block 710, C_SIZE and C_SIZE_MULT, READ_BL_LEN are read from the CSD register 214 of the memory card 102.

At block 712, the UserDataCapacity may be calculated by Equation 2A below with the information obtained from the CSD register 214 by block 710.
UserDataCapacity=BLOCKNR*BLOCK_LEN Equation 2A:

Where BLOCKNR may be computed from Equations 2B and 2C, and BLOCK_LEN may be computed from Equation 2D below.
BLOCKNR=(C_SIZE+1)*MULT Equation 2B:
MULT=2^{C}^{_{—}}^{SIZE}^{_{—}}^{MULT+2} Equation 2C:
BLOCK_LEN=2^{READ}^{_{—}}^{BL}^{_{—}}^{LEN} Equation 2D:

For example, as discussed previously we assumed that the total memory capacity of the memory card illustrated in FIGS. 6A-6C was Sixty-four megabytes (64 MB) which is equal to 67,108,864 Bytes. Now further assume that the C_SIZE and C_SIZE_MULT, READ_BL_LEN register values are read out from the CSD register as C_SIZE=0x0F27 or 0F27hex or 3879 decimal; C_SIZE_MULT=3; and READ_BL_LEN=9. In which case, the UserDataCapacity may be calculated as follows:
BLOCK_LEN=2^{READ}^{_{—}}^{BL}^{_{—}}^{LEN}=2⁹=512
MULT=2^{C}^{_{—}}^{SIZE}^{_{—}}^{MULT+2}=₂³⁺²=2⁵=32
BLOCKNR=(C_SIZE+1)*MULT=(3879+1)*MULT=3880*32 BLOCKNR=124160
UserData Capacity=BLOCKNR*BLOCK_LEN
UserDataCapacity=124160*512=63569920 Bytes

At block 714, the total spare memory capacity (TSMC) of the Spare Blocks from all banks may be calculated using Equation 2E as follow below.
TotalSpareMemoryCapacity=TotalMemoryCapacity−UserDataCapacity Equation 2E:

Substituting the values computed using the exemplary 64 MB memory card, the TotalSpareMemoryCapacity is computed as follows.
TotalSpareMemoryCapacity=67108864 Bytes−63569920 Bytes=3538944 Bytes

Note that the value of TotalSpareMemoryCapacity is not an exact number of total internal hidden area. This is because this value includes memory that can be used as system memory area and protected memory area, if any. However, this value does represent the maximum value of total internal hidden area or total spare memory capacity provided by the total number of spare blocks.

At block 716, step 3 is performed to calculate the size of the internal hidden memory size per bank (HMSB 632) and the size (BlockSize 634) of a block 128,128′ in a bank. The hidden memory size per bank (HMSB 632) is calculated by dividing the Total Spare Memory Capacity (TSMC) by the Total Number of Banks (TNB) in accordance with Equation 3 below.
HiddenMemorySizePerBank=TotalSpareMemoryCapacity/TotalNumberBanks Equation 3:

Continuing with our example of FIGS. 6A-6C, there was a total of four banks and the Total Spare Memory Capacity was computed to be 3538944 bytes. Inputting these numbers into Equation 3A we can determined the hidden memory size per bank HMSB 632 as follows.
HiddenMemorySizePerBank=3538944 Bytes/4=884736 Bytes

At blocks 718 and 720, step 4 is performed to calculate the size (BlockSize 634) of a block 128,128′ in a bank. For an SD memory card, the BlockSize 634 may be calculated from register information stored in the CSD register 214 of an SD memory card.

At block 718, WRITE_BL_LEN and SECTOR_SIZE are read from the CSD register 214 of the memory card 102. BlockSize 634 is calculated from the SECTOR_SIZE and WRITE_BL_LEN which are defined in CSD register.

At block 720, the size (BlockSize 634) of one block 128,128′ is calculated in accordance with Equation 4 below.
BlockSize=2^{WRITE}^{_{—}}^{BL}^{_{—}}^{LEN}*SECTOR_SIZE Equation 3:

Assume for the exemplary 64 MB memory card of FIGS. 6A-6C, that SECTOR_SIZE is read to be 0x20, 20hex, or 32 decimal and WRITE_BL_LEN is read out to be equal to READ_BL_LEN having a decimal value of 9.
SECTOR_SIZE=0x20
WRITE_BL_LEN=(READ_BL_LEN)=9

Substituting these values into equation 4, the BlockSize can be calculated as follows:
BlockSize=2⁹*20hex
BlockSize=512*32=16384 Bytes

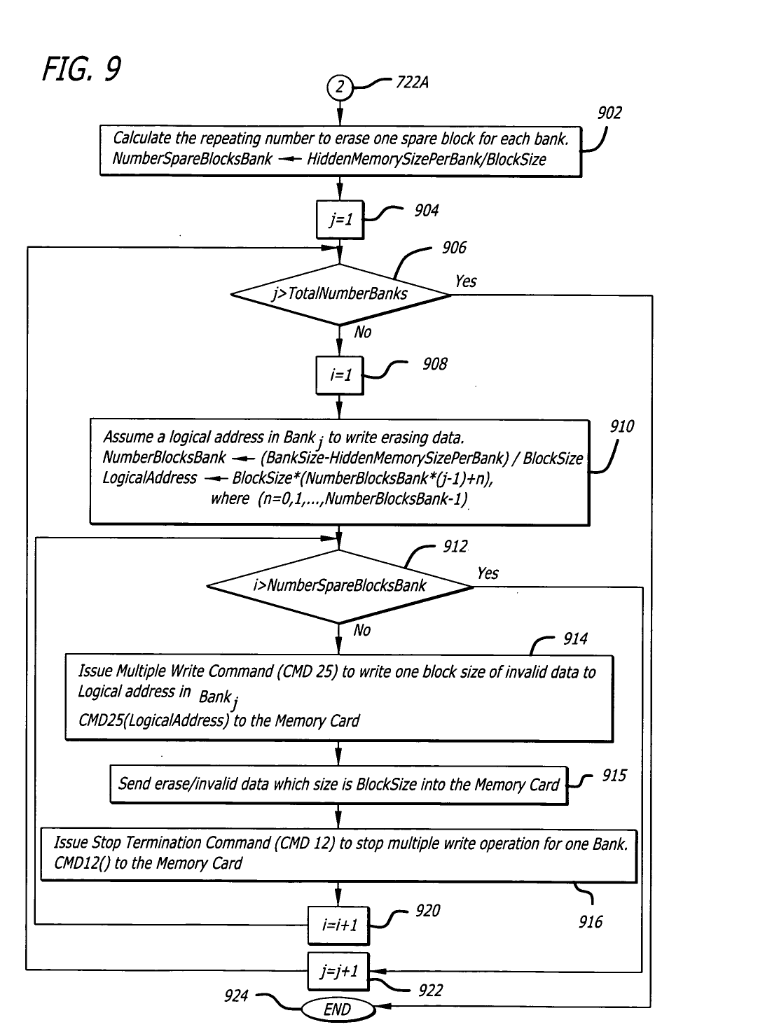

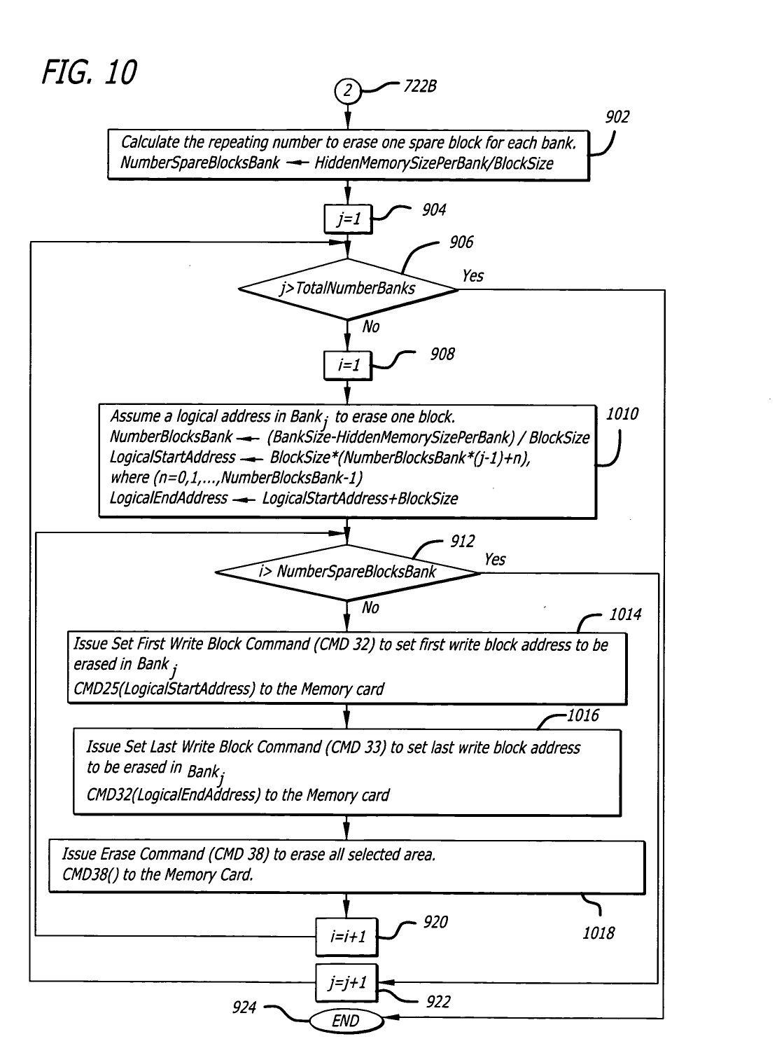

After determining these values, the inaccessible or hidden memory can be securely erased using invalid data to overwrite memory locations by multiple write operations illustrated by the flowchart of FIG. 9, or by erasing the memory locations using multiple erase operations illustrated by the flowchart of FIG. 10.

Reference is now made to FIG. 9 using multiple write operations to securely erase data in a memory card.

At block 902, step 5 is performed to determine the number of times to write invalid data into one block in each bank in order to overwrite the spare blocks 128′ of memory. The number of times to write invalid data is the same as the number of spare blocks per bank (NumberSpareBlocksBank or NSBB 636). In each case, the number of spare blocks per bank (NumberSpareBlocksBank or NSBB 636) is determined by dividing the Hidden Memory Size per bank by the BlockSize that may be calculated using Equation 5 below.
NumberSpareBlocksBank=HiddenMemorySizePerBankIBlockSize Equation 5:

The calculation of HiddenMemorySizePerBank HMSB 632 and BlockSize 634 were previously discussed with reference to FIG. 7.

Continuing with the Example of FIGS. 6A-6C, it was previously determined that HiddenMemorySizePerBank was 8845736 bytes and the block size was 16384 bytes. Substituting these values into Equation 5 we find that
NumberSpareBlocksBank=884736 Bytes/16384 Bytes=54

Thus in order to securely erase a bank 626 of the memory 624 including the spare blocks 628′, 54 blocks of invalid data should be written into the same logical address within the given bank.

In the flowchart of FIG. 9, a pair of loops are set up. One loop is for writing data into a given bank and another loop is to move from bank to bank.

At block 904, a variable “j” is initialized to 1.

At block 906, a determination is made as to whether or not j is greater than the TotalNumberBanks (TNB). If it is, then the routine jumps to block 924 and is ended. If not, then the routine jumps to block 908.

At block 908, a variable “i” is initialed to 1.

At block 910, a logical address is determined to repeatedly write the invalid data into a given Bank j where j is a variable. The number of user accessible memory blocks per bank (NumberBlocksBank) is initially determined by subtracting the amount of hidden memory per bank (HiddenMemorySizePerBank) from the amount of memory per bank (BankSize) and then dividing the result by the amount of memory per block (BlockSize). For each Bank j, j is incremented. Thus, the variable j may increment the logical address by the NumberBlocksBank from one bank to another. The logical address may be also be offset within the given Bank j by a number of BlockSizes by the selection of the variable n. The variable n can incrementally vary over the range of 0 through (NumberBlocksBank−1).

At block 912, a determination is made as to whether or not “i” is greater than the number of spare blocks per bank NumberSpareBlocksBank (NSBB). If it is, then the routine jumps to block 922. If not, then the routine jumps to block 914.

At block 922, the variable j is incremented by one indicating a new bank of memory may be processed and the routine jumps back to block 906.

At block 914, step 6 is performed to write invalid data (i.e. Erase data) to the same logical address in a bank j. The size of invalid data to write during the write operation is the same as the size (BlockSize) of a block calculated previously in step 4 at block 720.

Multiple Write commands (CMD 25) are issued to the SD memory card to this logical address.

For Example, assuming the address is used to write invalid data into the 1^{st} bank of memory, the logical address will be in the range set from 0x00000000 to (0x00CA0000−BlockSize). The notation “0x” indicates a hexadecimal number follows.

The BlockSize was previously determined to be 16384 bytes. Substituting the BlockSize into the range we find the actual logical address range to be from 0x00000000 to 0x00C9C000.

The logical address selected to write the invalid data is preferably in alignment with a block of memory by using the BlockSize that was determined in step 4 at block 720.

For example, invalid data is a data pattern of “0×FF”, FF hex, or 11111111 binary which is written into the memory card at the logical address “0x00800000” for the 1^{st} bank in the memory card.

At block 915, the invalid data (i.e., Erase/Delete Data) of a BlockSize is sent to the memory card to be written starting at the selected logical address. The invalid data is a pattern of data having no significance such as all ones, all zeroes, alternating ones and zeroes, or random ones and zeroes.

At block 916, after writing one block of invalid data using the selected logical address, a Stop Termination command (CMD 12) is issued to stop the multiple write operation.

At block 920, the variable “i” is incremented by one indicating a new block may be processed and the routine jumps back to block 912.

Instead of using Multiple Write operations to overwrite data, it is possible to use multiple Erase operations to clear the data. In that case, the command Set First Write Block is issued and the erase command (CMD 32) is also issued. Next a command Set Last Write Block is issued (CMD 33), then an Erase command (CMD 38) is issued. This described below with reference to the flowchart of FIG. 10.

Blocks 914, 915, and 916 are repeated for the number of spare blocks per bank (NumberSpareBlocksBank) as a step 7. That is, step 6 of blocks 914, 915, and 916 are repeated for the number of spare blocks per bank (NumberSpareBlocksBank). In this manner, the initial spare blocks are sure to be swapped out into the accessible memory area so that they can be overwritten.

In the continuing example, NumberSpareBlocksBank was 54. Thus, blocks 914, 915, and 916 are to be repeated 54 times.

Block 910 in conjunction with the loop including blocks 914, 915, and 916 are repeated for each bank for a total number of banks (TotalNumberBanks) as a step 8. That is, steps 6 and 7 are repeated for the total number of banks previously calculated in block 708. The starting logical address of a bank is changed in block 910 when moving from one bank to the next in order to erase/overwrite the internal hidden memory area.

Continuing with the example of FIGS. 6A-6C, the total number of banks TotalNumberBanks was computed to be 4. The 1^{st} Bank address was “0x00800000” or 00800000hex that was used to issue the multiple write operations.

The following addresses may be used to issue the multiple write operations in alignment with a block for the remaining banks as follows:
2^{nd} Bank: “0x01800000” or 01800000hex
3^{rd} Bank: “0x02800000” or 02800000hex
4^{th} Bank: “0x03800000” or 03800000hex

As discussed previously, Step 0 of block 702 may be performed after step (8) instead of at the beginning as is shown and described. That is, the function of block 702 would be moved to precede the end at block 924.

Referring now to FIG. 10, multiple Erase operations may be used to clear the data from the memory core instead of using Multiple Write operations to overwrite the data. The flowchart of FIG. 10 is somewhat similar to the flowchart of FIG. 9 having similar elements with the same reference numbers (902, 904, 906, 908, 912, 920, 922, 924). The function of these similar elements in FIG. 10 are described in detail with reference to FIG. 9 and is not repeated here for reasons of brevity. However, blocks having reference numbers 1010, 1014, 1016, 1018 in FIG. 10 differ from that of FIG. 9.

The flowchart of FIG. 10 illustrates a pair of loops as does the flowchart of FIG. 9, one loop for the number of spare blocks and another loop for the number of banks in the core memory of the memory card. The conditions in the loops in each are similar for continuing in the loop or jumping to different blocks or ending the software routine.

At block 1010 differing from block 910, a logical start address (LogicalStartAddress) is selected as in block 910. Block 1010 additionally computes a logical end address (LogicalEndAddress) by adding the BlockSize of one block of memory to the logical start address (LogicalStartAddress).

At block 1014, a Set First Write Block Command (CMD 32) is issued to the SD memory card to set the logical start address of the block being erased in the given bank j.

At block 1016, a Set Last Write Block Command (CMD 33) is issued to the SD memory card to set the logical end address of the block being erased in the given bank j.

At block 1018, an Erase Command (CMD 38) is issued to the SD memory card to erase all the area (i.e., the block) selected by the logical start address and the logical end address.

Blocks 1014, 1016, and 1018 are repeated in a loop for the total number of spare blocks that are in each bank. Block 1010 is repeated in a loop for the total number of banks as processing moves from bank to bank in the memory core.

When implemented in software, the elements of the embodiments of the invention are essentially the code segments to perform the necessary tasks. The program or code segments can be stored in a processor readable storage medium or transmitted by a computer data signal embodied in a carrier wave over a transmission medium or communication link. The “processor readable storage medium” may include any medium that can store or transfer information such as magnetic, optical, electronic, and electromagnetic mediums. Examples of the processor readable medium include an electronic circuit, a semiconductor memory device, a read only memory (ROM), a flash memory (EEPROM), an erasable ROM (EROM), electrically programmable ROM (EPROM), a floppy diskette, a compact disk read only memory (CDROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described. For example, one embodiment of the invention in a system was shown and illustrated that may include a computer system but the invention may be embodied in other types of electronic devices such as digital still cameras, digital video cameras, digital audio players, cellular telephones, electronic books, and/or electronic dictionaries, for example.

It will, however, be evident that various modifications and changes may be made thereto without departing from the broader spirit and scope of the present invention as set forth in the appended claims. Therefore, the specification and drawings are accordingly to be regarded in an illustrative rather than in a restrictive sense.

1. A method for securely erasing a memory card, the method comprising:
determining a size of a hidden memory region within a storage medium of the memory card;
issuing a first command to erase a block of data stored in the hidden memory region; and
repeating the issuing of the first command to erase a block of data in response to the size of the hidden memory region.

2. The method according to claim 1, wherein
the command issued to erase the block of data is an erase command to erase flash memory cells.

3. The method according to claim 1, wherein
the command issued to erase the block of data is a write command to overwrite data stored in flash memory cells with a data pattern.

4. The method according to claim 1, wherein
the data pattern is one of a random data pattern, an all zero data pattern, an all one data pattern, an alternating one and zero data pattern, and a random data pattern.

5. The method according to claim 1, further comprising:
issuing a second command to erase an accessible memory region within the storage medium of the memory card.

6. The method according to claim 5, wherein
the second command is issued prior to the issuing of the first command.

7. The method according to claim 5, wherein
the first command is issued prior to the issuing of the second command.

8. The method according to claim 1, wherein
the memory card is a secure digital (SD) memory card and
the storage medium is a plurality of electrically erasable programmable read only memory cells.

9. The method according to claim 1, wherein
the determining of the size of the hidden memory region within the storage medium of the memory card includes determining the size of a block of memory in a bank of memory.

10. The method according to claim 9, wherein
the determining of the size of the hidden memory region within the storage medium of the memory card further includes
determining a user data capacity and subtracting the user data capacity from a total memory capacity of the memory card to determine a capacity of the hidden memory region.

11. The method according to claim 10, wherein
the determining of the size of the hidden memory region within the storage medium of the memory card further includes
determining a number of blocks within the hidden memory region by dividing the capacity of the hidden memory region by the size of the block of memory.

12. The method according to claim 1, wherein
the first command is issued by a host system to the memory card to erase the one or more bytes of data stored in the hidden memory region.

13. A method for securely erasing a memory card, the method comprising:
determining a number of memory banks in the memory card;
determining a size of a block of memory in each memory bank;
determining a number of hidden spare blocks of memory in an inaccessible region of each memory bank; and
repeatedly erasing a block of memory in each memory bank up to the number of hidden spare blocks of memory in the inaccessible region of each memory bank.

14. The method according to claim 13, further comprising:
erasing blocks of memory in the accessible region of each memory bank.

15. A method for securely erasing a memory card, the method comprising:
determining a number of memory banks in the memory card;
determining a size of a block of memory in each memory bank;
determining a number of hidden spare blocks of memory in an inaccessible region of each memory bank; and
repeatedly overwriting a block of memory with a data pattern in each memory bank up to the number of hidden spare blocks of memory in the inaccessible region of each memory bank.

16. The method according to claim 13, further comprising:
overwriting blocks of memory with the data pattern in the accessible region of each memory bank.

17. The method according to claim 16, wherein
the data pattern is one of a random data pattern, an all zero data pattern, an all one data pattern, an alternating one and zero data pattern, and a random data pattern.

18. An apparatus for securely erasing a memory card, the apparatus comprising:
a determination means to determine a number of spare blocks of a hidden memory region within each bank of a storage medium of the memory card;
a first command generating means to generate a first command to erase all blocks of data stored in an accessible memory region of each bank; and
a second command generating means to generate a second command to erase a block of data stored in a spare block of the hidden memory region in each bank; and
wherein the second command generating means to repeatedly generate the second command in response to the number of spare blocks in each bank.

19. The apparatus according to claim 18, wherein
the first command overwrites all blocks of data with a data pattern,
the second command overwrites each block of data stored in each spare block with the data pattern, and
wherein the data pattern is one of a random data pattern, an all zero data pattern, an all one data pattern, an alternating one and zero data pattern, and a random data pattern.

20. The apparatus according to claim 18, wherein
the first command erases all blocks of data using an erase command,
the second command erases each block of data stored in each spare block using an erase command.

21. A computer program product, comprising:
a processor readable storage medium;
program code recorded in the processor readable storage medium to determine a number of spare blocks within a hidden memory region of each memory bank within the memory card;
program code recorded in the processor readable storage medium to generate a first command to erase blocks of data stored in the spare blocks of the hidden memory region of each memory bank in response to the number of spare blocks within the hidden memory region of each memory bank; and
program code recorded in the processor readable storage medium to generate a second command to erase blocks of data within accessible memory regions of each memory bank.

22. The computer program product according to claim 21, wherein
the processor readable storage medium is one or more of the set of magnetic storage medium, optical storage medium, and semiconductor storage medium.

23. A computer program product, comprising:
a processor readable storage medium;
program code recorded in the processor readable storage medium to determine a number of memory banks in the memory card;
program code recorded in the processor readable storage medium to determine a size of a block of memory in each memory bank;
program code recorded in the processor readable storage medium to determine a number of hidden spare blocks of memory in an inaccessible region of each memory bank; and
program code recorded in the processor readable storage medium to repeatedly erase a block of memory in each memory bank up to the number of hidden spare blocks of memory in the inaccessible region of each memory bank.

24. The computer program product according to claim 23, further comprising:
program code recorded in the processor readable storage medium to erase blocks of memory in the accessible region of each memory bank.

25. The computer program product according to claim 23, wherein
the processor readable storage medium is one or more of the set of magnetic storage medium, optical storage medium, and semiconductor storage medium.

26. A computer program product, comprising:
a processor readable storage medium;
program code recorded in the processor readable storage medium to determine a number of memory banks in the memory card;
program code recorded in the processor readable storage medium to determine a size of a block of memory in each memory bank;
program code recorded in the processor readable storage medium to determining a number of hidden spare blocks of memory in an inaccessible region of each memory bank; and
program code recorded in the processor readable storage medium to repeatedly overwrite a block of memory with a data pattern in each memory bank up to the number of hidden spare blocks of memory in the inaccessible region of each memory bank.

27. The computer program product according to claim 26, further comprising:
program code recorded in the processor readable storage medium to overwrite blocks of memory with the data pattern in the accessible region of each memory bank.

28. The computer program product according to claim 26, wherein
the data pattern is one of a random data pattern, an all zero data pattern, an all one data pattern, an alternating one and zero data pattern, and a random data pattern.

29. The computer program product according to claim 26, wherein
the processor readable storage medium is one or more of the set of magnetic storage medium, optical storage medium, and semiconductor storage medium.

30. A system comprising:
memory coupled to a bus, the memory to store a program having instructions;
a processor coupled to the bus;
a memory card controller coupled to the bus;
a memory card connector coupled to the memory card controller;
a flash memory card coupled to the memory card connector, the flash memory card having a flash memory; and,
wherein the system executes the instructions of the program to securely erase the flash memory, including spare blocks within a hidden memory area of the flash memory.

31. The system according to claim 30, further comprising:
an input device coupled to the bus, the input device to receive inputs from a user; and
a display device coupled to the bus.

32. The system according to claim 31, further comprising:
a display controller coupled between the bus and the display device.

33. The system according to claim 30, wherein one of the processor, the memory card controller, and the flash memory card executes the instructions of the program to securely erase the flash memory.

34. The system according to claim 33, wherein
the instructions of the program to securely erase the flash memory include
instructions to determine a number of spare blocks within a hidden memory region of each memory bank within the memory card; and
instructions to generate a first command to erase blocks of data stored in the spare blocks of the hidden memory region of each memory bank in response to the number of spare blocks within the hidden memory region of each memory bank.

35. The system according to claim 34, wherein
the instructions of the program to securely erase the flash memory further include
instructions to generate a second command to erase blocks of data within accessible memory regions of each memory bank.

36. The system according to claim 30, wherein
the flash memory card includes
a flash memory core to store data therein;
a controller coupled to the flash memory core, the controller to control the reading, writing, and erasing of data with the flash memory core; and
a plurality of pads coupled to the controller, the plurality of pads to couple the flash memory card to the card connector.
